(19) United States
(12) Patent Application Publication
(10) Pub. No.: US 2026/0217584 A1
(43) Pub. Date: Jul. 30, 2026

(54) LIQUID COMPOSITE THALLIUM REMOVAL AGENT AND PREPARATION METHOD AND APPLICATION THEREOF

(71) Applicant: South China Normal University, Guangzhou (CN)

(72) Inventors: Bo Yan, Guangzhou (CN); Tianyang Hao, Guangzhou (CN); Shuchen Tu, Guangzhou (CN); Tao Chen, Guangzhou (CN); Linghui Kuang, Guangzhou (CN); Hui Huang, Guangzhou (CN); Chengyu Zhou, Guangzhou (CN); Zemin Li, Guangzhou (CN)

(21) Appl. No.: 19/430,706

(22) Filed: Dec. 23, 2025

(30) Foreign Application Priority Data
Jan. 26, 2025 (CN) 202510122559.X

(51) Int. Cl. C02F 9/00; C02F 1/28; C02F 1/52; C02F 1/66; C02F 101/20

(52) U.S. Cl. CPC C02F 9/00; C02F 1/281; C02F 1/283; C02F 1/288; C02F 1/5245; C02F 1/5272; C02F 1/66; C02F 2101/20

(57) ABSTRACT

A liquid composite thallium removal agent, a preparation method and an application are provided. The liquid composite thallium removal agent is a first mixed solution obtained by mixing a soluble titanium salt and a dilute sulfuric acid, and then adding an adsorption carrier and a titanium salt dispersion catalyst to the first mixed solution to obtain a second mixed solution; heating the second mixed solution to boiling, then refluxing and cooling, and adjusting a pH to weakly alkaline. The present disclosure further discloses a method for removing thallium from thallium containing wastewater using the liquid composite thallium removal agent. The present disclosure provides a convenient process for removing thallium from desulfurization wastewater containing thallium, with good stability of thallium removal effect and low cost. The raw materials used are environmentally friendly agents, which will not cause secondary pollution and are suitable for treating large-scale thallium containing wastewater.

### CROSS-REFERENCE TO RELATED APPLICATIONS

This application claims priority to Chinese Patent Application No. 202510122559.X, filed on Jan. 26, 2025, which is hereby incorporated by reference in its entirety.

### TECHNICAL FIELD

The present disclosure relates to the field of wastewater treatment technologies, and in particular, to a liquid composite thallium removal agent and a preparation method and an application thereof.

### BACKGROUND

Thallium is a highly toxic dispersed metal, with much higher toxicity than heavy metal ions such as arsenic, cadmium, and lead under equivalent conditions, second only to methylmercury. Due to its strong sulfur affinity, thallium is usually found in sulfur-containing minerals such as sphalerite, pyrite, and high sulfur coal. In industrial production processes such as mineral sintering and thermal power generation, thallium often enters the desulfurization system with sulfur-containing smoke and eventually accumulates in desulfurization wastewater, thereby forming high concentration thallium containing desulfurization wastewater. If this type of wastewater is discharged directly without effective thallium removal treatment, it will cause serious pollution to surface water, groundwater, and soil. Thallium may also enter crops through enrichment effects, thereby posing a threat to human life, health, and ecological security.

At present, the treatment technologies for thallium containing wastewater mainly include adsorption method, oxidation coagulation precipitation method, solvent extraction method, and ion exchange method. Although the oxidation coagulation precipitation method can effectively remove thallium from wastewater and reduce it to trace levels, its application is limited due to high reagent costs, complex operations, and the possibility of secondary pollution. Although solvent extraction and ion exchange methods have good selectivity for heavy metal ions, they are not suitable for treating thallium containing desulfurization wastewater due to the large amount of industrial desulfurization wastewater, large fluctuations in water quality, and complex composition.

Adsorption method has become an important direction for studying the treatment of thallium containing wastewater due to its advantages of high efficiency, economy, and low secondary pollution. This method achieves the removal of thallium ions by electron transfer between thallium ions in water and the surface of adsorbent materials, thereby forming chemical bonds. At present, various adsorption materials have been studied for the treatment of thallium containing wastewater, such as carbon materials, biomass materials, and metal oxides. However, existing adsorption materials generally suffer from limited adsorption capacity, insufficient chemical stability, complex preparation processes, or high costs, which restrict their large-scale application in industrial wastewater treatment.

In existing technology, adsorbents are mostly in solid form, such as particles, powders, or supported materials. This type of solid adsorbent has problems such as difficulty; in addition, uneven dispersion, and reduced adsorption efficiency in practical applications, especially in the complex and variable water quality environment of thallium containing desulfurization wastewater, which makes it difficult to meet the needs of large-scale industrial treatment. But liquid adsorbents have unique advantages: they have higher dispersibility, can fully contact with wastewater, and significantly improve adsorption efficiency. The liquid form is convenient for precise additions through pumping equipment and easier to operate. At the same time, a preparation process of liquid adsorbents can avoid the high-temperature calcination or post-treatment steps involved in traditional solid adsorbents, which helps to reduce preparation costs and resource consumption.

However, the research and application of liquid adsorbents are still in the preliminary exploration stage. There is still a lack of development and application methods for liquid adsorbents in the treatment of thallium containing wastewater in existing technology, especially in improving adsorption efficiency, enhancing chemical stability, and reducing secondary pollution, and research is not sufficient.

### SUMMARY

Based on the needs and existing gaps in the above-mentioned fields, the present disclosure has developed a liquid adsorbent with high adsorption capacity, strong stability, and easy addition, which not only makes up for the shortcomings of existing solid adsorbents, but also provides a new solution for the efficient treatment of thallium containing desulfurization wastewater.

The specific technical solution is as follows.

A first aspect of the present disclosure provides a liquid composite thallium removal agent, it is a first mixed solution of a soluble titanium salt and a dilute sulfuric acid, and a second mixed solution is obtained by adding an adsorption carrier and a titanium salt dispersed catalyst to the first mixed solution; heating the second mixed solution to boiling, then refluxing and cooling, and adjust a pH to weakly alkaline.

In some embodiments of the present disclosure, the soluble titanium salt is selected from one or more of titanium sulfate, titanium oxysulfate, titanium tetrachloride, and titanium tetrabromide.

The titanium salt dispersed catalyst is ethylene glycol monomethyl ether.

The adsorption carrier is 50-200 mesh activated carbon.

In some embodiments of the present disclosure, a weight ratio of the soluble titanium salt to the dilute sulfuric acid is 10-30:100-5000; a concentration of the dilute sulfuric acid is 1 mmol/L-500 mmol/L; the weak alkalinity refers to a pH of 7-9.

In some embodiments of the present disclosure, a weight ratio of the adsorption carrier, the titanium salt dispersed catalyst, and the first mixed solution is 5-20:3-10:250-1500.

Another aspect of the present disclosure provides a method for preparing a liquid composite thallium removal agent, including the following steps:
1). mixing a soluble titanium salt with a dilute sulfuric acid evenly to obtain a first mixed solution;
2). adding an adsorption carrier and a titanium salt dispersed catalyst to the first mixed solution, stirring evenly, and preparing a second mixed solution;
3). heating the second mixed solution to boiling, refluxing to cooling, adjusting a pH of a solution to alkalescence to obtain the liquid composite thallium removal agent.

In some embodiments of the present disclosure, a reflux treatment time is 0.5-2 hours; adjusting the pH of the solution using one or more of sodium hydroxide, sodium carbonate, and sodium bicarbonate.

In a still one aspect of the present disclosure provides a process for removing thallium from desulfurization wastewater containing thallium, where the process is shown in FIG. 1 and includes the following steps:
S1. adjusting a pH of a to-be-treated thallium desulfurization wastewater to 6-9 to obtain an adjusted wastewater;
S2. adding the liquid composite thallium removal agent to the regulated wastewater and reacting under a stirring condition;
S3. adding a coagulant and a flocculant to the wastewater after completing the reaction, mixing the reaction and letting it settle, performing a solid-liquid separation, and discharging an upper clear liquid, thus achieving a thallium removal from the wastewater.

In some embodiments of the present disclosure, a concentration of the thallium in the wastewater is 100 μg/L-5 mg/L; pH adjustment is carried out using a combination of one or more of sulfuric acid, caustic soda liquid or lime milk.

In some embodiments of the present disclosure, an addition amount of the liquid composite thallium removal agent accounts for 0.3%-1% of a volume of the regulated wastewater; a specific addition amount can be adjusted according to the concentration of thallium ions in the wastewater and water quality conditions to achieve the best adsorption effect.

In step S2, a reaction time under a stirring condition is 0.5-2 hours; in step S3, a mixing reaction time is 0.2-2 hours, and a settling time is 15-45 minutes.

In some embodiments of the present disclosure, the coagulant is a mixture of 5-10 parts by weight of polyaluminum chloride, 3-6 parts by weight of 100 mesh activated carbon, and 3000-10000 parts by weight of water; an addition amount of the coagulant accounts for 0.08%-0.15% of the volume of the regulated wastewater.

The flocculant is a mixture of 5-10 parts by weight of polyacrylamide and 3000-6000 parts by weight of water; the addition amount of the flocculant accounts for 0.05% to 0.08% of the volume of the regulated wastewater.

The present disclosure considers that thallium in wastewater mainly exists in the form of T¹⁺, and the core component of the liquid composite thallium removal agent is active titanium dioxide, which has a large specific surface area and abundant adsorption sites. Under alkaline conditions, active titanium dioxide efficiently removes T¹⁺ from wastewater through surface chemical adsorption. Unlike traditional solid adsorbents, liquid composite thallium removal agents have higher dispersibility and more complete contact with wastewater. They not only significantly improve adsorption efficiency, but also greatly simplify the operation process, rendering them particularly suitable for the continuous treatment needs of industrial wastewater.

In the coagulation and flocculation stage, the aggregation ability of particles is first enhanced by coagulants, and then the active titanium dioxide adsorbed with TH and suspended particles are aggregated into larger flocs through the adsorption bridging and net trapping and sweeping effects of coagulants. This synergistic effect effectively improves the settling performance, making the solid-liquid separation process more efficient, and stabilizing the supernatant after treatment to meet the standard for discharge.

This application has at least the following beneficial technical effects.

This application provides a liquid composite thallium removal agent and the thallium desulfurization wastewater thallium removal process. Compared with traditional solid adsorbents, liquid composite thallium removal agents have higher dispersibility and can be accurately added through peristaltic pumps or metering pumps, thereby fully contacting with wastewater and significantly improving adsorption efficiency. Its preparation adopts the heating reflux method, which promotes the thorough mixing of raw materials, catalysts, and carriers through homogenization operation, generating an active titanium dioxide adsorbent with uniform particle size, stable dispersion, and low agglomeration. The adsorption performance is significantly improved, and it can adapt to the complex and fluctuating water quality conditions of sulfur-containing desulfurization wastewater. The liquid form simplifies the dosing process and workflow, rendering it more suitable for continuous treatment of industrial wastewater.

The preparation method of the liquid composite thallium removal agent in this application is simple, using soluble titanium salts, dilute sulfuric acid, and environmentally friendly additives as raw materials, with low cost and green environmental protection. By hydrolyzing titanium salts to generate active titanium dioxide, the adsorption capacity and chemical stability of thallium ions are significantly improved, ensuring long-term and reliable thallium removal efficiency. The process avoids the complex drying, calcination, and washing steps of traditional solid adsorbents, does not generate secondary pollution, has high preparation efficiency, and is convenient for industrial promotion. The sludge generated after treatment is easy to dispose of in the future, and the overall process is environmentally friendly and efficient.

The process for removing thallium from desulfurization wastewater containing thallium in this application has the characteristics of simple process, stable effect, and low cost. By adjusting the pH of the wastewater and adding liquid composite thallium removal agent and flocculant, efficient removal of thallium ions can be achieved through mixing, reaction, and precipitation separation. The process involves fewer types of additives and fewer operational steps, and the treated supernatant can be directly discharged to meet the standard, meeting the large-scale treatment needs of thallium containing wastewater. It is particularly suitable for industrial wastewater environments with complex water quality and variable composition.

### BRIEF DESCRIPTION OF DRAWINGS

FIG. 1 is a flowchart of a method for removing thallium from desulfurization wastewater containing thallium in the present application.

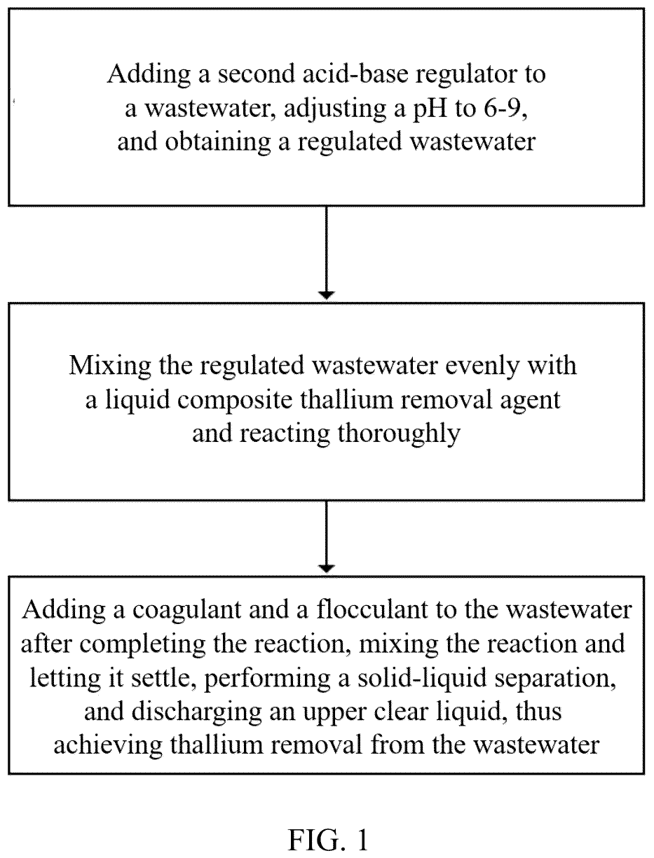

FIG. 2 shows a scanning electron microscope image and an EDS spectrum of liquid composite thallium removal agent No. 1, where (a), (b), and (c) are scanning electron microscope images of the liquid composite thallium removal agent No. 1; (d) is an EDS spectrum of the liquid composite thallium removal agent No. 1.

FIG. 3 shows a scanning electron microscope image and an EDS spectrum of liquid composite thallium removal agent No. 2; where (a), (b), and (c) are scanning electron microscope images of the liquid composite thallium removal agent No. 2; (d) is an EDS spectrum of liquid composite thallium removal agent No. 2.

FIG. 4 shows a scanning electron microscope image and an EDS spectrum of liquid composite thallium removal agent No. 3; where (a), (b), and (c) are scanning electron microscope images of liquid composite thallium removal No. 3; (d) is an EDS spectrum of liquid composite thallium removal No. 3.

FIG. 5 shows a particle size distribution of liquid composite thallium removal agents No. 1, No. 2, and No. 3 in an embodiment.

### DESCRIPTION OF EMBODIMENTS

The following provides an exemplary description of the technical solution of the present disclosure through specific embodiments, which should not be considered as limiting the protection scope of the present disclosure.

### Example 1: Liquid Composite Thallium Removal Agent and a Preparation Method Thereof of the Present Disclosure

This application discloses a liquid composite thallium removal agent, which is a first mixed solution obtained by mixing a soluble titanium salt and a dilute sulfuric acid, and then adding an adsorption carrier and a titanium salt dispersed catalyst to the first mixed solution to obtain a second mixed solution; heating the second mixed solution to boiling, then refluxing and cooling, and adjusting a pH to weakly alkaline.

Specifically, it is prepared through the following steps
S1. Weighing 10-30 parts by weight of soluble titanium salt and slowly adding it to 100-5000 parts by weight of dilute sulfuric acid, and maintaining uniform stirring to ensure that the titanium salt is fully dissolved and evenly dispersed, avoiding uneven crystallization or hydrolysis caused by an excessive local concentration. After the mixing is complete, continue stirring for 10-20 minutes until the solution is completely clear and there are no precipitates or suspended particles. Finally, the first mixed solution is obtained.

The soluble titanium salts can be one or more of titanium sulfate, titanium oxysulfate, titanium tetrachloride, and titanium tetrabromide. A concentration range of the dilute sulfuric acid is 1 mmol/L-500 mmol/L.
S2. Taking 250-1500 parts by weight of the first mixed solution, adding 5-20 parts by weight of the adsorption carrier and 3-10 parts by weight of the titanium salt dispersed catalyst in sequence, stirring evenly, and preparing a second mixed solution.
S3. Heating the second mixed solution to boiling and refluxing until cooled, then adding a first acid-base regulator to adjust the pH of the solution to 7-9, thus preparing the liquid composite thallium removal agent.

In an implementation mode, the adsorption carrier is 50-200 mesh activated carbon, and the first acid-base regulator can be one or more combinations of sodium hydroxide, sodium carbonate, and sodium bicarbonate, with a reflux time of 0.5-2 hours.

The advantage of this step is that by adding the adsorption carrier and catalyst to the first mixed solution, combined with the heating reflux process, the titanium salt is uniformly hydrolyzed to generate active titanium dioxide, which exists stably in liquid form. The liquid adsorbents have excellent dispersibility and can be uniformly loaded on the surface of activated carbon, ensuring high adsorption efficiency and adaptability to different wastewater quality conditions.

### Example 2: Effects of Different Catalysts on the Performance of Liquid Composite Thallium Removal Agent

Weighing 30 parts by weight of titanium sulfate and 30 parts by weight of titanium oxysulfate, dissolving them in 3000 parts by weight of dilute sulfuric acid with a concentration of 0.3 mol/L, and stirring thoroughly until completely dissolved. Subsequently, adding 45 parts by weight of activated carbon with a particle size of 100 mesh and continue stirring to evenly disperse it. The obtained solution is divided into three equal parts, named first mixed solution I, first mixed solution II, and first mixed solution III.

In the first mixed solution I, adding 5 parts by weight of ethylene glycol monomethyl ether as a catalyst, stirring evenly, heating to boiling, and maintaining under reflux conditions for 1 hour. After the solution cooling down, adding sodium bicarbonate to adjust the pH to 8.5, and finally obtaining a liquid composite thallium removal agent No. 1.

In the first mixed solution II, 5 parts by weight of acetic acid were added as a catalyst, and the same operating conditions as the mixed solution I were used. After stirring evenly, it was heated to boiling and kept under reflux conditions for 1 hour. After the solution cools down, adding sodium bicarbonate to adjust the pH to 8.5, and finally obtaining a liquid composite thallium removal agent No. 2.

The first mixed solution III was used as a control group without adding any catalyst. According to the same operating conditions as the mixed solutions I and II, stirring evenly and heating to boiling, and maintaining under reflux conditions for 1 hour. After the solution cooling down, adding sodium bicarbonate to adjust the pH to 8.5, and finally obtaining a liquid composite thallium removal agent No. 3.

To analyze the microstructure and particle size distribution of various liquid composite thallium removal agents, a small amount of liquid composite thallium removal agent No. 1, liquid composite thallium removal agent No. 2, and liquid composite thallium removal agent No. 3 were taken, filtered, and the filter residue was washed with pure water and dried. The dried samples were characterized using scanning electron microscopy (SEM) and Malvern laser particle size analyzer to evaluate their particle dispersion, particle size distribution, and specific surface area.

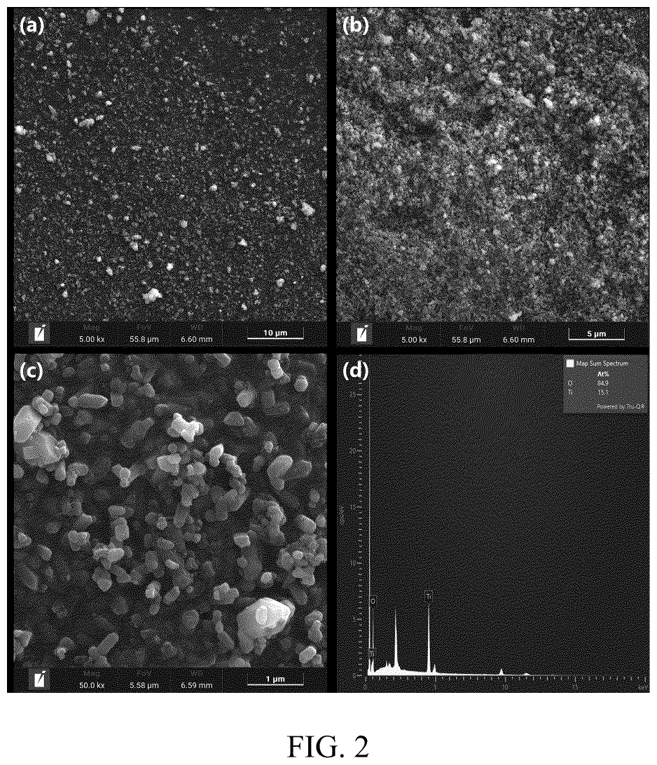

As shown in FIGS. 2-5, there are significant differences in the morphology and particle size distribution of liquid composite thallium removal agent No. 1, liquid composite thallium removal agent No. 2, and liquid composite thallium removal agent No. 3.

As shown in FIG. 2, the liquid composite thallium removal agent No. 1 exhibits the best particle size and dispersibility, with particle size concentrated between 1-5 μm, significant particle uniformity, and no obvious agglomeration phenomenon. The SEM image clearly demonstrates the advantages of particle dispersion and specific surface area. Energy dispersive spectroscopy (EDS) analysis shows that titanium dioxide is fully generated, and the ratio of titanium to oxygen meets the design expectations. The high dispersibility and uniformity make the liquid composite thallium removal agent No. 1 have a larger specific surface area and abundant adsorption sites, rendering it an ideal material for efficient adsorption of thallium ions.

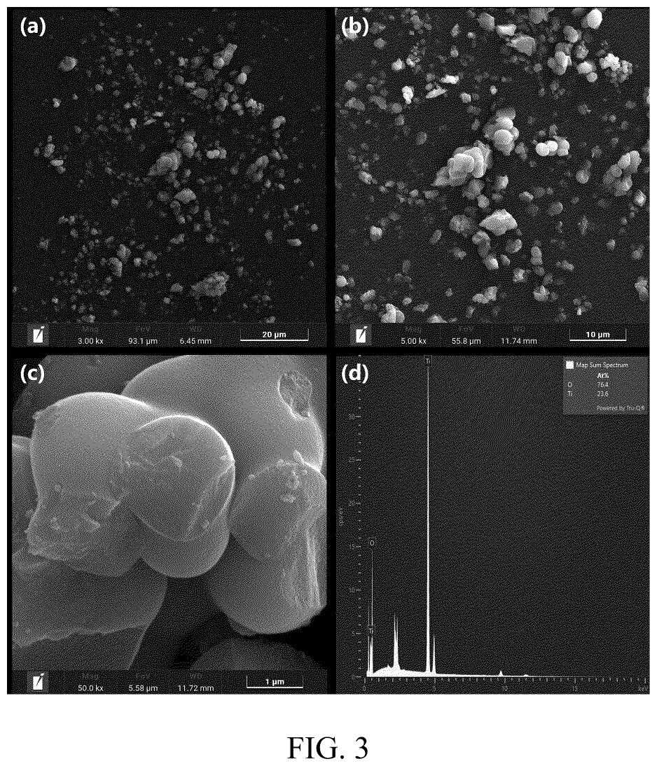

As shown in FIG. 3, the particle size range of liquid composite thallium removal agent No. 2 is wider, mainly distributed between 20-40 μm, and the particle uniformity is inferior to that of liquid composite thallium removal agent No. 1. SEM images show that some particles have smooth surfaces, but there is a certain degree of agglomeration phenomenon, and the particle size distribution deviation is large, which may lead to a decrease in specific surface area. Energy spectrum analysis shows that the distribution of titanium and oxygen is more uneven compared to the liquid composite thallium removal agent No. 1. Although acetic acid can partially regulate the hydrolysis process of titanium salts, its effect is far less significant than that of ethylene glycol monomethyl ether, resulting in a higher degree of particle aggregation and limited performance.

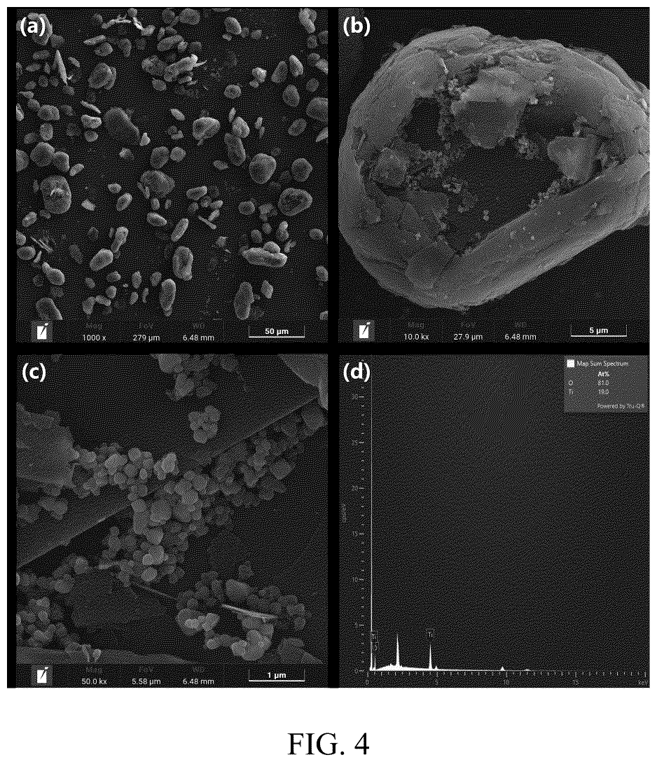

As shown in FIG. 4, the performance of liquid composite thallium removal agent No. 3 is the worst, with the widest particle size distribution, a large number of particles exceeding 50 μm, and severe agglomeration phenomenon. SEM images show irregular particle shapes, rough surfaces, and even the formation of large agglomerates. The EDS analysis results showed that the content of titanium and oxygen was significantly low, indicating insufficient generation of titanium dioxide and much lower adsorption performance of particles compared to liquid composite thallium removal agents No. 1 and No. 2.

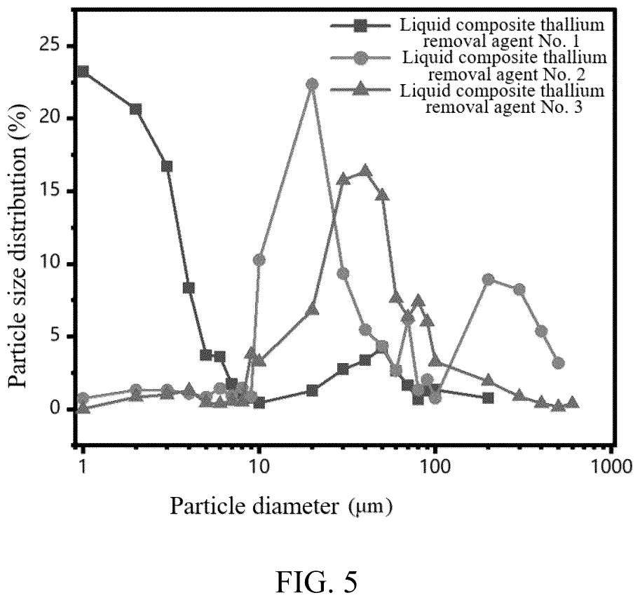

As shown in FIG. 5, in order to further verify the above results, the particle size distribution of liquid composite thallium removal agent No. 1 is the most concentrated and the particle uniformity is the best. The distribution range of liquid composite thallium removal agent No. 2 is wide and the uniformity is moderate. The liquid composite thallium removal agent No. 3 showed the widest particle distribution, significant agglomeration phenomenon, and the worst performance.

The experimental results show that ethylene glycol monomethyl ether plays a significant dispersing role in the hydrolysis process of soluble titanium salts, which helps to uniformly dissolve the titanium salts and generate titanium dioxide particles with concentrated particle size distribution, thereby significantly improving the performance of liquid composite thallium removal agent No. 1. But the effect of acetic acid is limited, and the liquid composite thallium removal agent No. 3 without catalyst exhibits significant disadvantages due to the uncontrolled hydrolysis process.

### Example 3: Treatment of Thallium Containing Wastewater Using the Liquid Composite Thallium Removal Agent of the Disclosure

In this embodiment, 10 parts by weight of titanium sulfate and 10 parts by weight of titanium oxysulfate were dissolved in 1000 parts by weight of dilute sulfuric acid with a concentration of 0.3 mol/L. After sufficient dissolution, 15 parts by weight of 100 mesh activated carbon and 5 parts by weight of ethylene glycol monomethyl ether were added and stirred evenly. Heating the mixed solution to boiling, and refluxing for 1 hour. After cooling, adding sodium bicarbonate and adjusting a pH of a solution to 8.5 to prepare the liquid composite thallium removal agent.

### Example 4: Treatment of Thallium Containing Wastewater Using the Liquid Composite Thallium Removal Agent of the Present Disclosure

In this embodiment, the preparation of liquid composite thallium removal agent is as follows: 15 parts by weight of titanium sulfate and 5 parts by weight of titanium tetrachloride are dissolved in 1500 parts by weight of dilute sulfuric acid with a concentration of 0.5 mol/L. After sufficient dissolution, 10 parts by weight of 100 mesh activated carbon and 8 parts by weight of ethylene glycol monomethyl ether were added, and stirring evenly. Heating the mixed solution to boiling, and refluxing for 1 hour. After cooling, adding sodium bicarbonate and sodium hydroxide to gradually adjust a pH of a solution to 8 to prepare the liquid composite thallium removal agent.

### Wastewater Treatment Steps

S1. Taking 10000 parts by weight of thallium containing desulfurization wastewater (initial pH of 6.6, total thallium content of 412 μg/L), adjusting the pH of the wastewater to 8.5 by adding NaOH and lime milk, and generating regulated wastewater suitable for thallium ion adsorption.
S2. Adding 100 parts by weight of liquid composite thallium removal agent to the regulated wastewater, stirring evenly and reacting for 30 minutes to allow the active titanium dioxide to fully adsorb thallium ions in the wastewater.
S3. Adding 8 parts by weight of coagulant (made by mixing 5 parts by weight of polyaluminum chloride, 6 parts by weight of 100 mesh activated carbon, and 10000 parts by weight of water) and 6 parts by weight of flocculant (made by mixing 5 parts by weight of polyacrylamide and 5000 parts by weight of water) to the wastewater after the reaction, stirring and mixing for 1 hour, then letting it settle for 45 minutes to complete a solid-liquid separation and discharging an upper clear liquid. After testing, the thallium concentration in a treated wastewater (upper clear liquid) was reduced to 0.93 μg/L, and a thallium removal rate exceeded 99%, meeting the wastewater discharge standards and environmental protection requirements.

### Example 5: Treatment of Thallium Containing Wastewater Using the Liquid Composite Thallium Removal Agent of the Present Disclosure

In this example, 15 parts by weight of titanium sulfate and 5 parts by weight of titanium tetrachloride were dissolved in 1500 parts by weight of dilute sulfuric acid with a concentration of 0.5 mol/L. After sufficient dissolution, 10 parts by weight of 100 mesh activated carbon and 8 parts by weight of ethylene glycol monomethyl ether were added and stirred evenly. Heating the mixed solution to boiling; and refluxing for 1 hour. After cooling, adding sodium bicarbonate and sodium hydroxide, gradually adjusting a pH of a solution to 8, and preparing the liquid composite thallium removal agent.

### Wastewater Treatment Steps

S1. Taking 10000 parts by weight of thallium containing desulfurization wastewater (initial pH of 6.6, total thallium content of 412 μg/L), adjusting the pH of the wastewater to 8.5 by adding NaOH and lime milk, and generating regulated wastewater suitable for thallium ion adsorption.
S2. Adding 100 parts by weight of liquid composite thallium removal agent to the regulated wastewater, stirring evenly and reacting for 30 minutes to allow the active titanium dioxide to fully adsorb thallium ions in the wastewater.
S3. Adding 8 parts by weight of coagulant (made by mixing 10 parts by weight of polyaluminum chloride (PAC), 5 parts by weight of 100 mesh activated carbon, and 6000 parts by weight of water) and 6 parts by weight of flocculant (made by mixing 6 parts by weight of anionic polyacrylamide (PAM) and 3000 parts by weight of water) to the wastewater after the reaction. After stirring evenly and reacting for 1 hour, letting it settle for 45 minutes to complete a solid-liquid separation, and discharge an upper clear liquid.

After testing, the thallium concentration in the treated wastewater (upper clear liquid) was reduced to 0.93 μg/L, and the thallium removal rate exceeded 99%, meeting the wastewater discharge standards and environmental protection requirements.

### Example 6: Treatment of Thallium Containing Wastewater Using the Liquid Composite Thallium Removal Agent of the Disclosure

In this example, 10 parts by weight of titanium sulfate, 5 parts by weight of titanium oxysulfate, and 5 parts by weight of titanium tetrachloride were dissolved in 1000 parts by weight of dilute sulfuric acid with a concentration of 0.3 mol/L. After sufficient dissolution, 15 parts by weight of 100 mesh activated carbon and 5 parts by weight of ethylene glycol monomethyl ether were added and stirred evenly. Heating the mixed solution to boiling; and refluxing for 1.5 hours. After cooling, adding sodium bicarbonate and sodium hydroxide to gradually adjust a pH of a solution to 9 to prepare the liquid composite thallium removal agent.

### Wastewater Treatment Steps

S1. Taking 10000 parts by weight of thallium containing desulfurization wastewater (initial pH 6.0, total thallium content 375 μg/L), adjusting the pH of the wastewater to 8.8 by adding NaOH, and generating regulated wastewater suitable for thallium ion adsorption.
S2. Adding 90 parts by weight of liquid composite thallium removal agent to the regulated wastewater, stirring evenly and reacting for 40 minutes to fully adsorb thallium ions in the wastewater with active titanium dioxide.
S3. Adding 7 parts by weight of coagulant (made by mixing 15 parts by weight of polyaluminum chloride, 8 parts by weight of 100 mesh activated carbon, and 6000 parts by weight of water) and 10 parts by weight of flocculant (made by mixing 5 parts by weight of anionic polyacrylamide (PAM) and 3000 parts by weight of water) to the wastewater after the reaction. After stirring, mixing, and reacting for 0.5 hours, letting it settle for 30 minutes to complete a solid-liquid separation, and discharging an upper clear liquid.

After testing, the thallium concentration in the treated wastewater (upper clear liquid) was reduced to 1.89 μg/L, and the thallium removal rate exceeded 99%, meeting the wastewater discharge standards and environmental protection requirements.

The above is only a specific implementation of the present application, but the protection scope of the present application is not limited to this. Any changes or replacements that can be easily thought of by those skilled in the art within the technical scope disclosed in the present application should be included in the protection scope of the present application. Therefore, the protection scope of this application should be based on the protection scope of the claimed rights.

1. A method for preparing a liquid composite thallium removal agent, comprising the following steps:
1) mixing a soluble titanium salt with a dilute sulfuric acid evenly to obtain a first mixed solution;
2) adding an adsorption carrier and a titanium salt dispersed catalyst to the first mixed solution, stirring evenly, and preparing a second mixed solution, the titanium salt dispersed catalyst is ethylene glycol monomethyl ether;
3) heating the second mixed solution to boiling, refluxing to cooling, adjusting a pH of a solution to 7-9 to obtain the liquid composite thallium removal agent;
wherein a weight ratio of the soluble titanium salt to the dilute sulfuric acid is 10-30:100-5000; a concentration of the dilute sulfuric acid is 1 mmol/L-500 mmol/L;
wherein the adsorption carrier is activated carbon.

2. The method according to claim 1, wherein the soluble titanium salt is selected from one or more of titanium sulfate, titanium oxysulfate, titanium tetrachloride, and titanium tetrabromide;
wherein the activated carbon is 50-200 mesh activated carbon.

3. The method according to claim 1, wherein a weight ratio of the adsorption carrier, the titanium salt dispersed catalyst, and the first mixed solution is 5-20:3-10:250-1500.

4. The method according to claim 3, wherein a reflux treatment time is 0.5-2 hours; adjusting the pH of the solution to 7-9 using one or more of sodium hydroxide, sodium carbonate, and sodium bicarbonate.

5. A liquid composite thallium removal agent prepared by the method according to claim 1.

6. A process for removing thallium from desulfurization wastewater containing thallium, comprising the following steps:
S1. adjusting a pH of a to-be-treated thallium desulfurization wastewater to 6-9 to obtain an adjusted wastewater;
S2. adding the liquid composite thallium removal agent according to claim 5 to the regulated wastewater and reacting under a stirring condition;
S3. adding a coagulant and a flocculant to the wastewater after completing the reaction, mixing the reaction and letting it settle, performing a solid-liquid separation, and discharging an upper clear liquid, thus achieving thallium removal from the wastewater.

7. The process for removing thallium according to claim 6, wherein a concentration of the thallium in the wastewater is 100 μg/L-5 mg/L;
in step S1, pH adjustment is carried out using a combination of one or more of sulfuric acid and caustic soda liquid.

8. The process for removing thallium according to claim 6, wherein in step S2, an addition amount of the liquid composite thallium removal agent accounts for 0.3%-1% of a volume of the regulated wastewater;
in step S2, a reaction time under a stirring condition is 0.5-2 hours;
in step S3, a mixing reaction time is 0.2-2 hours, and a settling time is 15-45 minutes.

9. The process for removing thallium according to claim 6, wherein the coagulant is a mixture of 5-10 parts by weight of polyaluminum chloride, 3-6 parts by weight of 100 mesh activated carbon, and 3000-10000 parts by weight of water;
wherein an addition amount of the coagulant accounts for 0.08%-0.15% of the volume of the regulated wastewater;
the flocculant is a mixture of 5-10 parts by weight of polyacrylamide and 3000-6000 parts by weight of water;
the addition amount of the flocculant accounts for 0.05%-0.08% of the volume of the regulated wastewater.
